(19) United States
(12) Patent Application Publication
(10) Pub. No.: US 2009/0200440 A1
(43) Pub. Date: Aug. 13, 2009

(54) Hangable article for wiping

(75) Inventor: Isaac Paul Franco, Tel-Aviv (IL)

Correspondence Address: MARTIN D. MOYNIHAN d/b/a PRTSI, INC., P.O. BOX 16446, ARLINGTON, VA, 22215, US

(73) Assignee: Franco Lewenstein Investments Ltd., Shenzhen (CN)

(21) Appl. No.: 12/068,714

(22) Filed: Feb. 11, 2008

(51) Int. Cl. F16B 47/00; A47F 5/08

(52) U.S. Cl. 248/205.5; 248/363; 248/205.1

(57) ABSTRACT

A hangable cloth assembly for wiping hands or objects. The hangable cloth assembly comprises a flexible absorbent sheet of flexible fabric for absorbing moisture and a single attachment unit is releasably engageable with a relatively flat surface. The attachment unit is disposed on the flexible absorbent sheet, optionally in an undetachable manner. The flexible absorbent sheet is designed to be engaged with the relatively flat surface in a single point of contact.

### FIELD AND BACKGROUND OF THE INVENTION

The present invention, in some embodiments thereof, relates to an article for wiping and, more particularly, but not exclusively, to a hangable apparatus for wiping objects and hands.

Hangers for hanging towels and other elastic absorbent fabrics are known. A known conventional hanger includes a base and one or more hang rods as main components. The base further has insert holes to receive screws that allow the fixing of the base to a wall. The installation of such the hanger on the wall by the screws is rather complicated and inconvenient. The user has to drill holes in the wall in order to fix the screws. Furthermore, the drilling harms the wall and if the hanger is to be relocated, the holes remain and affect the appearance of the wall. In order to avoid such a complicated and inconvenient installation, a hanger that is fixed to wall using strong suction elements has been developed. Exemplary suction devices may be found in U.S. Pat. Nos. 355,021; 1,119,111; 2,657,893; 3,240,461; 3,747,170; 3,750,991; 4,012,007; 4,133,575; 4,580,751; 5,031,865; 5,087,005; 5,104,077; 5,176,346; 5,263,593; 5,366,129; 5,970,860; 6,308,923; 6,386,494; 6,402,104; 6,932,306, U.S. Patent Publication No. 2002/0190170; UK Patent Application No. GB 2275723A.

### SUMMARY OF THE INVENTION

According to an aspect of some embodiments of the present invention, there is provided a hangable cloth assembly for wiping. The hangable cloth assembly comprises a flexible absorbent sheet and a single attachment unit being releasably engageable with a relatively flat surface, the attachment unit being disposed on the flexible absorbent sheet. The hangable cloth assembly is configured to be engaged with the relatively flat surface in a single area of contact.

Optionally, the attachment unit is disposed in an undetachable manner.

Optionally, the flexible absorbent sheet is hanged freely during the engaging of the single attachment unit with the substantially flat surface.

Optionally, the attachment unit is at least one suction cup.

Optionally, the attachment unit is molded with at least a portion of the flexible absorbent sheet.

Optionally, the attachment unit is welded to the flexible absorbent sheet.

More optionally, the welding is performed using a member selected from a group consisting of: ultrasonic welding, radio frequency welding, thermal fusion, and reactive welding.

Optionally, the attachment unit is made from a resilient material.

Optionally, the attachment unit comprises lower and upper arched elements, each the arched element having a concave side and a convex side, the convex side of the lower arched element and the concave side of the upper arched element respectively covering opposite sides of the flexible absorbent sheet.

Optionally, the hangable wiping cloth assembly is disposable.

Optionally, the attachment unit comprises an opening element for supporting the disengaging thereof from the flat surface.

Optionally, the flexible absorbent sheet is triangular.

According to an aspect of some embodiments of the present invention, there is provided a hangable cloth assembly for wiping. The hangable cloth assembly comprises a flexible absorbent sheet and a single attachment unit being releasably engageable with a substantially flat surface, the attachment unit being disposed on the sheet. The flexible absorbent sheet is hanged freely during the engaging of the single attachment unit with the substantially flat surface.

According to an aspect of some embodiments of the present invention, there is provided a method for creating a hangable cloth assembly for wiping hands or objects. The method comprises providing a flexible absorbent sheet and welding an attachment unit to the flexible absorbent sheet. The attachment unit is configured for releasably engaging the hangable cloth assembly with a relatively flat surface in a single area of contact. The attachment unit is welded to allow the flexible absorbent sheet to be engaged with the relatively flat surface by the attachment unit only.

Optionally, the attachment unit is a suction cup.

Optionally, the attaching is performed using a member selected from a group consisting of: ultrasonic welding, radio frequency welding, thermal fusion, and reactive welding.

Optionally, the attachment unit is made from a resilient material.

More optionally, the resilient material comprises a member selected from a group consisting of: a natural rubber, a plasticized resin, butyl rubber, latex, vinyl plastic, and urethane.

Optionally the method further comprises placing a lower and an upper arched elements in opposite sides of the flexible absorbent sheet before b), each the arched element having a concave side and a convex side, the convex side of the lower arched element and the concave side of the upper arched element respectively covering opposite sides of the flexible absorbent sheet, the attaching comprises attaching the arched elements with the flexible absorbent sheet.

Optionally, the attaching comprises molding the attachment unit with at least a portion of the flexible absorbent sheet.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a hangable cloth assembly for wiping hands and/or objects, according to some embodiments of the present invention;

FIG. 2 is schematic illustration of the hangable cloth assembly of FIG. 1 when it is engaged with a relatively flat surface, according to some embodiments of the present invention;

FIG. 3 is a lateral schematic illustration the hangable cloth assembly of FIG. 2, according to some embodiments of the present invention;

FIG. 4 is a sectional schematic illustration of the hangable cloth assembly, according to some embodiments of the present invention;

FIG. 5 is a sectional schematic illustration of an exemplary attachment unit, according to some embodiments of the present invention; and

FIG. 6 is a lateral sectional illustration of the upper and lower sides of the exemplary attachment unit that is depicted in FIG. 5, according to some embodiments of the present invention.

### DESCRIPTION OF SPECIFIC EMBODIMENTS OF THE INVENTION

The present invention, in some embodiments thereof, relates to an article for wiping objects and hands and, more particularly, but not exclusively, to a hangable apparatus for wiping objects and hands.

In some embodiments of the present invention, a hangable cloth assembly that is designed to be engaged with a relatively flat surface, such as a wall, a closet door, and a window is described. The hangable cloth assembly is optionally designed to be connected to a flat surface in a single area of contact. As the hangable cloth assembly is not connected to any other elements or surfaces, it is relatively loose and therefore allows a user to use it comfortably for wiping his hands and/or objects, as further described below. The hangable cloth assembly comprises a sheet of flexible fabric, such as towel fabric, for absorbing moisture and a single attachment unit, such as suction cup that is releasably engageable with relatively flat surfaces. The single attachment unit is disposed on the sheet, optionally in an undetachable manner. The hangable cloth assembly does not require a hanger and may be engaged with various relatively flat surfaces, such as glass, metal, wood, marble, and ceramic tiles. Optionally, when the attachment unit is engaged with the relatively flat surface the, sheet is hanged freely. As further described below, the hangable cloth assembly may be used for wiping hands or dishes and/or for other domestic purposes.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

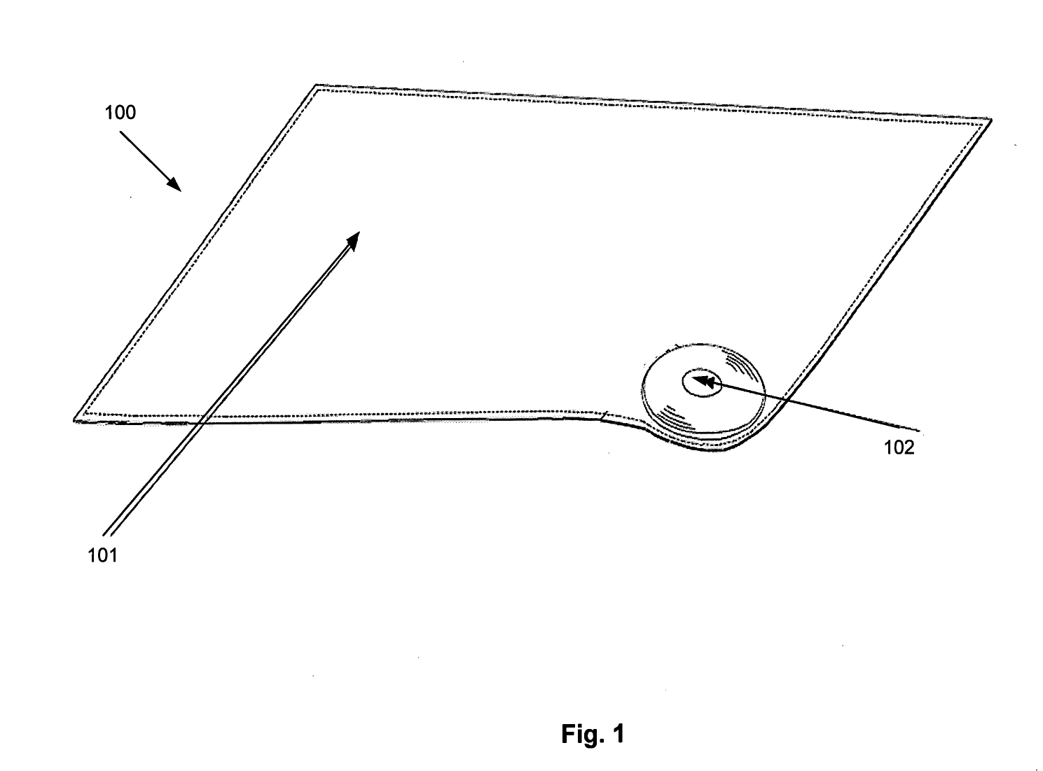

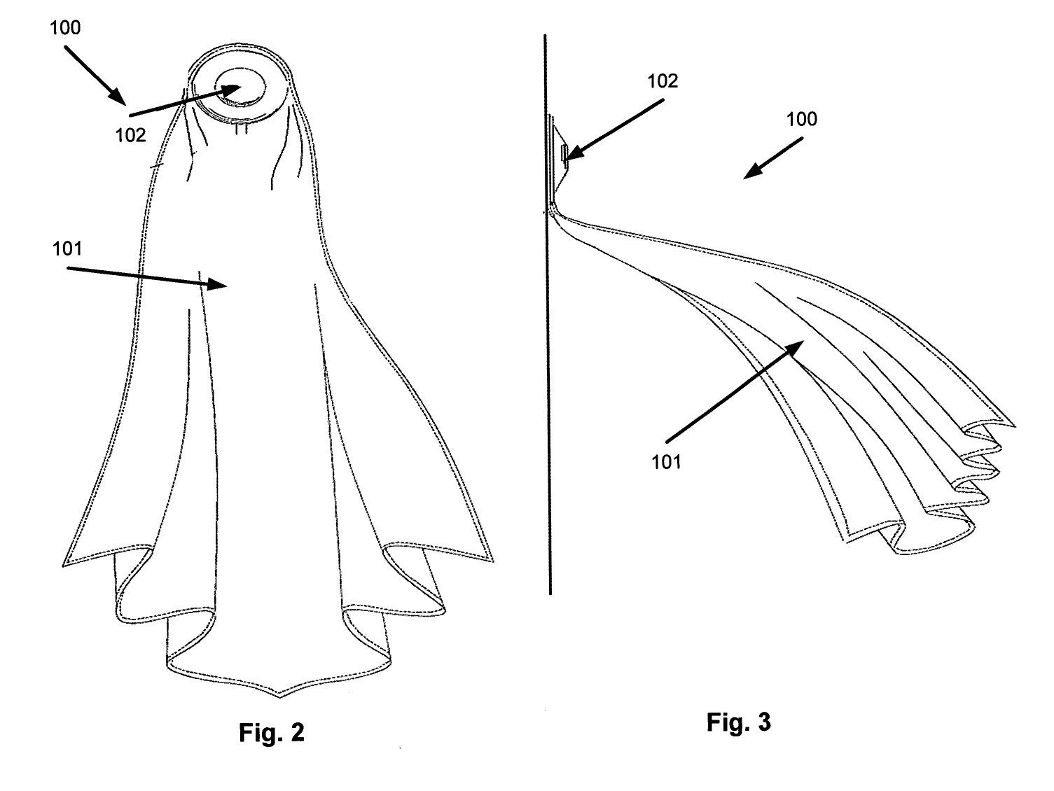

Reference is now made to FIG. 1, which is a schematic illustration of a hangable cloth assembly 100 for wiping hands and/or objects, according to some embodiments of the present invention. The hangable cloth assembly 100 includes a sheet of absorbent flexible sheet 101, such as a towel fabric and a single attachment unit 102, such as a suction cup, that is releasably engageable with a relatively flat surface. The single attachment unit 102 is designed to be engaged with a flat surface in a single area of contact. As used herein a single area of contact means one or more points of contact which are placed in a limited area in the proximity of the single attachment unit 102. Optionally, the towel fabric comprises cotton and/or synthetic fibers. As further described below, the single attachment unit 102 is disposed on the absorbent flexible sheet 101, optionally in an undetachable manner. Such a hangable cloth assembly 100 may find a particular application as a kitchen towel or for other domestic purposes wherein it is convenient for engaging the hangable cloth assembly 100 to a relatively flat surface, such as a wall, for example a ceramic wall, a closet door, and a window while the absorbent flexible sheet 101 is loosened, for example as shown at FIGS. 2 and 3. The losslessness of the absorbent flexible sheet 101, which is connected to a surface only in the area of contact between the attachment unit and the relatively flat surface, allows a user to use the absorbent flexible sheet 101 for easily wipe his hands and/or objects. It should be noted that the hangable cloth assembly 100 is not limited to domestic uses and may be engaged to a car window for the use of drivers and/or to a wall in a workplace, such as clinic or workshop where handcrafts, reparations, or manufacturing are made, allowing a craftsman to wipe his hands and/or objects in between tasks. The engaging of the hangable cloth assembly 100 to the relatively flat surface does not require a hanger and therefore may be done without tedious and/or extensive preparations. Furthermore, as the attachment unit 102 is integrated into the absorbent flexible sheet 101 and not provided as a separate hanger, the user of the hangable cloth assembly 100 can engage it to a flat surface without having to carry an additional hanger or attachment unit 102 and the attachment unit 102, which may have an undecorated look, does not remain engaged on the flat surface by itself.

Optionally, the absorbent flexible sheet 101 is rectangular. The single attachment unit 102 is optionally disposed at one of the corners of the absorbent flexible sheet 101, for example at shown at FIG. 1. Optionally, the absorbent flexible sheet 101 is triangular. A triangular absorbent flexible sheet 101 may have a wider side than a rectangular absorbent flexible sheet 101 that has the same area. Such a wide side can encircle bigger objects and/or hands without using a larger sheet. It should be noted that as only one single attachment unit 102 is used for engaging to the hangable cloth assembly 100 with the relatively flat surface, optionally as depicted in FIGS. 2 and 3, the width of the hanged hangable cloth assembly 100 is substantially thinner then the width of the absorbent flexible sheet 101.

Optionally, hangable cloth assembly 100 is used as a hand towel. In such an embodiment, the absorbent flexible sheet 101 is significantly smaller than a bath towel, optionally about 30×60 cm and is used for drying one's hands after washing them. Optionally, hangable cloth assembly 100 is used as a dish towel. In such an embodiment, the absorbent flexible sheet 101 is used to dry dishes and cutlery after they have been washed. In such embodiments, the single attachment unit 102 may be used to engage the hangable cloth assembly 100 to relatively flat surfaces of in a proximity to a sink and/or a water tap. Optionally, hangable cloth assembly 100 is used as a sports towel. In such an embodiment, the absorbent flexible sheet 101 is a super absorbent towel, which is made from a fabric that may absorb water and be squeezed to get the water out so it may be used again, for example as described in U.S. Pat. No. 6,383,614, filed on Apr. 27, 2000, which is disclosed herein by reference. Optionally, the hangable cloth assembly 100 is used as a sweat towel. In such an embodiment, the absorbent flexible sheet 101 is of similar size to a hand towel, and may be required in gyms in order to wipe down the machines after use. In such an embodiment, the single attachment unit 102 may be used to engage the hangable cloth assembly 100 to relatively flat surfaces of the workout equipment. Optionally, hangable cloth assembly 100 is used as a washcloth towel. In such an embodiment, the absorbent flexible sheet 101 is has the width of a hand towel, and is used by wetting, applying soap to the towel, and then using the towel to apply the soap to skin. This increases abrasion, and may remove dead skin cells from the skin more effectively than just manual application and rubbing of soap. In such an embodiment, the hangable cloth assembly 100 may be engaged to the walls of a bathtub or a shower-bath without a hanger or the like and/or to the ceramic walls in the proximity thereof. Optionally, the hangable cloth assembly 100 is used as a dust towel.

Optionally, hangable cloth assembly 100 is used as a disinfecting article. In such an embodiment, the absorbent flexible sheet 101 comprises a disinfecting material, such as Lysol and/or disinfecting agents such as chlorine. Such a hangable cloth assembly 100 may be used by physicians or other professionals for disinfecting their hands. The hangable cloth assembly 100 can be hanged on any flat surface and therefore can be used outside of the workplace of the user wherein there are not designated hangers for disinfecting cloths.

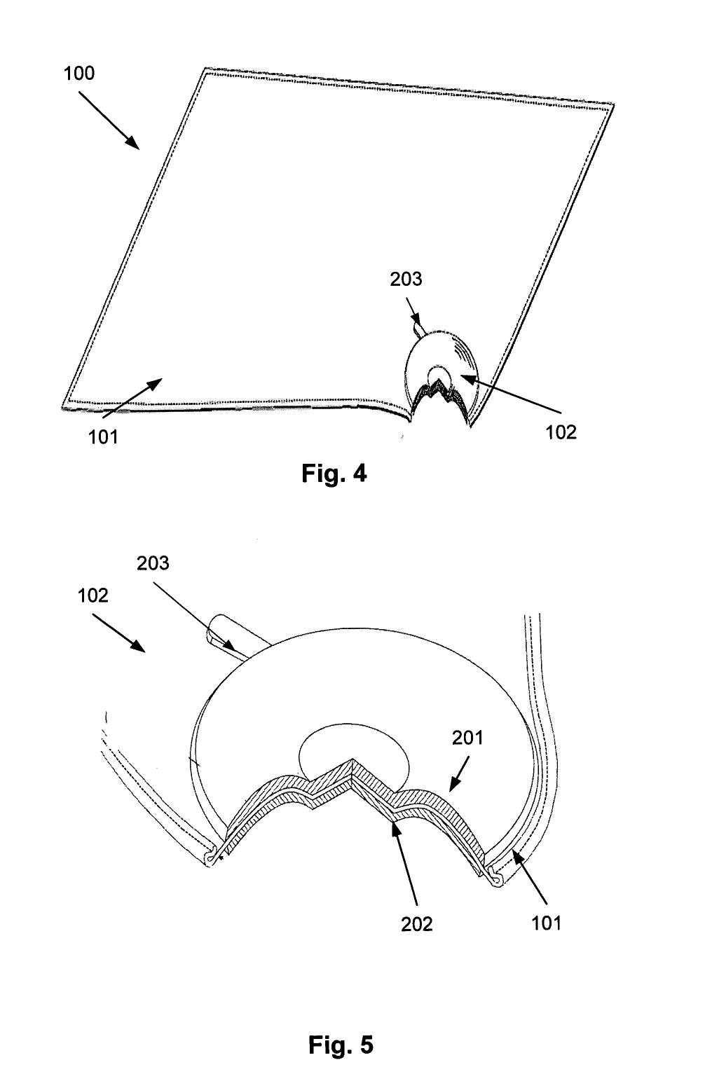

Reference is now also made to FIG. 4, which is a sectional schematic illustration of the hangable cloth assembly 100 and to FIG. 5, which is a sectional schematic illustration of an exemplary single attachment unit 102, according to some embodiments of the present invention. As described above, the single attachment unit 102 includes one or more suction cups. Optionally, single attachment unit 102 includes a suction cap that includes an upper element 201 and a lower element 202 which are placed in front of one another in opposite sides of the absorbent flexible sheet 101, for example as shown at FIG. 5. The upper and lower sides 201 202 are attached to opposite sides of the absorbent flexible sheet 101 by any method and/or means known in the art. Optionally, the upper and lower sides 201 202 are made from a resilient material, such as rubber, a plasticized resin, butyl rubber, latex, vinyl plastic, and/or urethane. Optionally, the upper and lower sides 201 202 are rigidly secured to the absorbent flexible sheet 101 using a known rubber and/or textile welding and/or molding techniques.

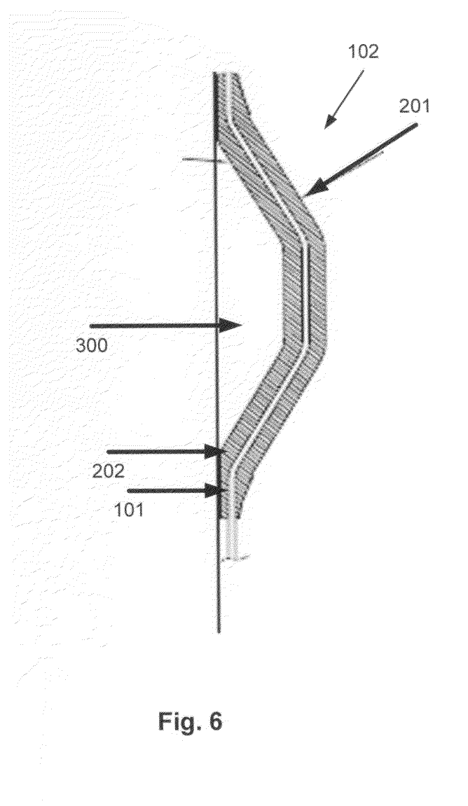

Reference is now also made to FIG. 6, which is a sectional illustration, from the side, of the upper and lower sides of the exemplary attachment unit that is depicted in FIG. 5, according to some embodiments of the present invention. As shown at FIG. 6, the upper and lower elements 201 202 are arched. In such an embodiment, the each one of the arched elements has a concave side and a convex side. The convex side of the lower arched element and the concave side of the upper arched element covers opposite sides of said sheet. When the suction cup 200 is placed against a relatively flat surface to which the hangable cloth assembly 100 is to be attached, a space 300 between the suction cup 200 and relatively flat surface is formed. The suction cup 200 is sufficiently pliable so that it may be pressed against the relatively flat surface. The pressing causes the concave surface to deform and flatten against the relatively flat surface. The deformation of the suction cup 102 extracted most of the air from the space 300, left it essentially empty of air, and creates a gaseous pressure that is lower than the atmospheric pressure around. The difference between the gaseous pressures holds the suction cup 200 in place. Furthermore, since the suction cup is made of a resilient material, optionally as describe above, it attempts to return to its original convex shape. Such an attempt creates a force that supports the pressure difference between the suction cup 200 and relatively flat surface.

Optionally, the lower element 201 is connected to an opening element, such as a reed, which may be referred to herein as a pressure release tab 203, that may be used by the user to release the pressure that is created by the suction cup 200 when it is attached to the relatively flat surface, as described above.

As described above, the single attachment unit 102 may be welded with the absorbent flexible sheet 101. Optionally, a technique such as ultrasonic welding, radio frequency welding, thermal fusion, and reactive welding, is used for the welding. Such welding techniques are known in the art, for example as described in U.S. Pat. No. 4,696,708 filed on Nov. 13, 1985, which the disclosure thereof is disclosed herein by reference. The welding of the single attachment unit 102 to the flexible sheet 101 increases the durability of the hangable cloth assembly 100 during the laundering thereof. It should be noted the hangable cloth assembly 100 has a higher durability then a cloth with a designated hanging opening as it has less seams. Furthermore, when the user removes the hangable cloth assembly 100 from the relatively flat surface it has been attached to, no mark or an empty hanger remains.

As the single attachment unit 102 is an integrated part of the hangable cloth assembly 100, the user is not limited to hang it on a specific hanging device and/or a projection that fits to the thickness of the cloth. The single attachment unit 102 may be attached to various relatively flat surfaces which are not designated for holding absorbent flexible fabrics, such as towels. The single attachment unit 102 may be engaged with relatively flat surfaces that have various angles. For clarity, the hangable cloth assembly 100 may be made for multiple uses, or alternatively, may be made inexpensively so as to be disposable after a limited number of uses.

It is expected that during the life of a patent maturing from this application many relevant apparatuses will be developed and the scope of the term suction cap and towel are intended to include all such new technologies a priori.

As used herein the term “about” refers to ±10% The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A hangable cloth assembly for wiping, comprising:
a flexible absorbent sheet; and
a single attachment unit being releasably engageable with a relatively flat surface, said attachment unit being disposed on said flexible absorbent sheet;
wherein said hangable cloth assembly is configured to be engaged with said relatively flat surface in a single area of contact.

2. The hangable wiping cloth assembly of claim 1, wherein said attachment unit is disposed in an undetachable manner.

3. The hangable wiping cloth assembly of claim 1, wherein said flexible absorbent sheet is hanged freely during the engaging of said single attachment unit with said substantially flat surface.

4. The hangable wiping cloth assembly of claim 1, wherein said attachment unit is at least one suction cup.

5. The hangable wiping cloth assembly of claim 1, wherein said attachment unit is molded with at least a portion of said flexible absorbent sheet.

6. The hangable wiping cloth assembly of claim 1, wherein said attachment unit is welded to said flexible absorbent sheet.

7. The hangable wiping cloth assembly of claim 6, wherein said welding is performed using a member selected from a group consisting of: ultrasonic welding, radio frequency welding, thermal fusion, and reactive welding.

8. The hangable wiping cloth assembly of claim 1, wherein said attachment unit is made from a resilient material.

9. The hangable wiping cloth assembly of claim 1, wherein said attachment unit comprises lower and upper arched elements, each said arched element having a concave side and a convex side, said convex side of said lower arched element and said concave side of said upper arched element respectively covering opposite sides of said flexible absorbent sheet.

10. The hangable wiping cloth assembly of claim 1, wherein said hangable wiping cloth assembly is disposable.

11. The hangable wiping cloth assembly of claim 1, wherein said attachment unit comprises an opening element for supporting the disengaging thereof from said flat surface.

12. The hangable wiping cloth assembly of claim 1, wherein said flexible absorbent sheet is triangular.

13. A hangable cloth assembly for wiping, comprising:
a flexible absorbent sheet; and
a single attachment unit being releasably engageable with a substantially flat surface, said attachment unit being disposed on said sheet;
wherein said flexible absorbent sheet is hanged freely during the engaging of said single attachment unit with said substantially flat surface.

14. A method for creating a hangable cloth assembly for wiping hands or objects, comprising:
a) providing a flexible absorbent sheet; and
b) welding an attachment unit to said flexible absorbent sheet, said attachment unit being configured for releasably engaging said hangable cloth assembly with a relatively flat surface in a single area of contact;
wherein said attachment unit is welded to allow said flexible absorbent sheet to be engaged with said relatively flat surface by said attachment unit only.

15. The method of claim 14, wherein said attachment unit is a suction cup.

16. The method of claim 14, wherein said attaching is performed using a member selected from a group consisting of: ultrasonic welding, radio frequency welding, thermal fusion, and reactive welding.

17. The method of claim 14, wherein said attachment unit is made from a resilient material.

18. The method of claim 17, wherein said resilient material comprises a member selected from a group consisting of: a natural rubber, a plasticized resin, butyl rubber, latex, vinyl plastic, and urethane.

19. The method of claim 14, further comprising placing a lower and an upper arched elements in opposite sides of said flexible absorbent sheet before b), each said arched element having a concave side and a convex side, said convex side of said lower arched element and said concave side of said upper arched element respectively covering opposite sides of said flexible absorbent sheet, said attaching comprises attaching said arched elements with said flexible absorbent sheet.

20. The method of claim 14, wherein said attaching comprises molding said attachment unit with at least a portion of said flexible absorbent sheet.
